(19) United States
(12) Patent Application Publication
(10) Pub. No.: US 2008/0227361 A1
(43) Pub. Date: Sep. 18, 2008

(54) Method and Device For Producing an Electroluminescent Luminous Element

(75) Inventor: Walter Kuebler, Oberrot (DE)

Correspondence Address: REISING, ETHINGTON, BARNES, KISSELLE, P.C., P O BOX 4390, TROY, MI, 48099-4390, US

(73) Assignee: SCHEFENACKER VISION SYSTEMS GERMANY GMBH, SCHWAIKHEIM (DE)

(21) Appl. No.: 11/995,458

(22) PCT Filed: Jul. 5, 2006
(86) PCT No.: PCT/EP06/06530

§ 371 Date: Jan. 25, 2008

(30) Foreign Application Priority Data
Jul. 12, 2005 (DE) 10-2005-033-714.7

(51) Int. Cl. H01J 9/12; H01J 9/00

(52) U.S. Cl. 445/46; 445/60

(57) ABSTRACT

Method and device for production of an electroluminescent light-emitting element The invention relates to a device and method for production of an electroluminescent light-emitting element (10), in which a transparent electrode layer (12) is deposited on a carrier (11) and a luminous pigment layer (13) and a counter-electrode layer (15) are deposited on the transparent electrode layer (12). According to the invention the transparent electrode layer (12) is structured electrochemically before the deposition on the luminous pigment layer (13).

The invention relates to a method and a device for the production of an electroluminescent light-emitting element according to the preamble of independent claims.

Light-emitting elements on the basis of electroluminescence are known. Besides light-emitting diodes, the so-called LEDs, light-emitting elements with large areas on rigid as well as on flexible carriers are known. In practice, film elements, produced on the basis of thick-film technology, and excited with alternating voltage fields, have proved to be value. In such elements, the luminous pigments are embedded in a transparent, organic or ceramic, binding agent. The luminous pigments usually contain binary compounds. The electric field is supplied through structured electrodes, of which, the front electrode, from which the electroluminescent radiation is emitted, consists of a transparent, electrically conducting material layer, for instance a very thin metal layer, or a transparent semiconductor, such as indium oxide or indium tin oxide (ITO). The rear electrode consists of a conducting metal layer. The luminous pigment layer, arranged between the front electrode and the rear electrode, possibly with an additional insulating layer, forms, together with its embedding device, the dielectric of a capacitor, for which reason the term “light-emitting capacitor” is oftentimes used for it. The light-emitting elements are nonlinear components, whose parameters are a function of the applied voltage and the frequency as well as also of the ambient conditions such as humidity and temperature.

The transparent electrode is frequently made of a synthetic material (for example polyester) coated with indium oxide or indium tin oxide. The luminous pigment can, for instance, be made of zinc sulfide, doped with different metals like Au, Ag, Cu, Ga or Mn. The color of the emitted light and the conductivity of the luminous pigment layer are determined by the strength and the composition of the doping. By varying the doping, color tones, ranging from blue to yellow, corresponding to the wavelengths of about 480 nm to 580 nm, can be generated, and by mixing the doping materials, compound colors resulting from it, such as, for instance, the compound color white, can be obtained. An insulation layer, for instance made of barium nitrate, applied on this luminous pigment layer, acts at the same time as a reflector. After that, the rear electrode, containing aluminum, carbon or silver lacquer for instance, is applied on it. Since zinc sulfide is heavily hygroscopic, an encapsulation, consisting of an intensively water-repelling material, is provided. However, raw pigment materials, in which zinc sulfide molecules are microencapsulated, are already available, so that the hygroscopic properties come less prominently to expression. Due to the large molecular distance, the luminance is slightly lower and not quite homogeneous. Film-like light-emitting elements of this type are sliceable, extremely thin, highly flexible and economical. Lamination is no longer absolutely necessary as such, but if done, it additionally increases the protection against moisture.

Since it is desirable that light-emitting elements have large surface areas, the structuring of the transparent front electrodes is particularly difficult. At the same time, the large surface area is however of advantage especially in serial manufacture.

The task of the invention is to provide an improved method and an improved device for the production of that type of flat electroluminescent light-emitting elements.

This task is resolved according to the invention by the features of the independent claims. Advantageous embodiments and advantages of the invention follow from the other claims and the description.

In the method of production of an electroluminescent light-emitting element according to the invention, in which a transparent electrode layer is deposited on a carrier and a luminous pigment layer and a counter-electrode layer are deposited on the transparent electrode layer, a roller electrode, impregnated with an acid, is brought in physical contact, in particular in rotary physical contact, with the transparent electrode. With that a local etching of the transparent electrode layer takes place. A preceding structuring, for instance using a mask technique during the deposition of the transparent electrode layer, or an elaborate masking and etching of the coated carrier in an etching bath, in which the carriers with large surface areas can be handled only with difficulty and in which the etching method is difficult to control, can be dispensed with. The transparent electrode layer must be removed from some areas of the carrier due to reasons related to the functioning of the light-emitting element, in order, for instance, to prevent appearance of an electric field outside the luminous pigment layer between the front electrode and the rear electrode. The roller electrode can be of equal size or longer than the width of the carrier and it should be possible to guide it lengthwise. However, alternatively, the roller electrode can also be shorter than the width of the carrier. Thinkable is further a roller electrode with a structured surface, with which it is possible to etch a strip-shaped pattern in the electrode layer.

The electrode layer can be applied over the entire area of the carrier and can be provided thereafter with a suitable structuring. The carrier can be rigid or it can be embodied as a film, in particular as a PET (PET=polyethylene terephthalate) film. The transparent electrode can be embodied as a very thin metal layer, which is only a few tenths of a nanometer thick, or can be made of a transparent semiconductor. Preferably indium oxide or indium tin oxide is used as the transparent semiconductor, which has adequate transparency even with layer thickness of several hundred nanometers. To improve the conductivity of the electrode layer, the semiconductor can also be doped. Preferably the electrode layer is deposited with CVD or PVD method (CVD=chemical vapor deposition, PVD=physical vapor deposition). It is particularly preferable if the electrode layer is prepared with cathode sputtering. Cathode sputtering has the advantage that the thermal stress of the carrier is smaller compared with the vapor deposition method and better adhesion of the layer is obtained due to the higher kinetic energy of the sputtered layer components. Further the sputtering can take place in a reactive atmosphere in order to induce oxide formation during the sputtering process, so that, for example, indium tin oxide forms on the carrier during the condensation.

If the roller electrode is displaced relatively to the transparent electrode layer, while an electric voltage is applied between the transparent electrode layer and the roller electrode, the carrier in a flat laminar pattern can be freed from the transparent electrode layer. The roller electrode can slide or roll above the carrier.

In an advantageous step of the method, the roller electrode can be rolled on the carrier during the etching. With that a homogeneous utilization of the acid or the acid layer carried along by the roller electrode can be achieved. The cauterized material gets distributed over the surface of the roller electrode and can for instance be delivered over an acid bath and/or cleaning bath. Larger areas can be treated before the acid gets exhausted due to the too high concentration of the cauterized material.

Preferably an electric voltage between 10 and 50 volts, preferably between 12 and 40 volts, can be applied. It is of advantage if the voltage is adjusted by a person skilled in the art in dependence of the type of the acid, type of the material to be cauterized, concentration, temperature and, where applicable, other processing parameters.

It is of advantage if the roller electrode can be impregnated with acid between the etching steps. This is especially meaningful with larger areas and/or in a serial process.

If the surface of the roller electrode is structured, on contact with roller electrode the carrier can be freed at the same time from the transparent electrode layer at areas provided specifically with recesses, and can produce, for instance, a strip-like pattern in a single processing step. The processing time for the treatment of large areas is shortened. Conceivable is also to provide several paths in the carrier material side by side and treat them with a single roller electrode.

It is advantageous if the carrier with the structured transparent electrode layer can be cleaned with water after the etching.

It is especially advantageous, if the roller electrode can be soaked with citric acid. In which case the waste disposal can take place without problems.

In a device for application of a method for the production of an electroluminescent light-emitting element according to the invention, a roller electrode is provided that can be impregnated with acid, with which the transparent electrode layer in some areas can be removed in course of its electrochemical path. Several roller electrodes can also be provided, in order to treat several parallel strip-shaped carriers, in particular films, in through-feed method.

It is of advantage if the roller electrode is arranged in a rotatable manner.

Devices that can actuate relative motion between the roller electrode and the carrier can also be provided.

In a suitable embodiment, the roller electrode can have a homogeneous surface. Alternatively, the roller electrode can have a structured surface with flat areas spaced by gaps. On contact with the coated carrier, the flat areas etch the transparent electrode layer, while the electrode layers in the gap areas remain intact.

It is of advantage if an acid is provided in which the roller electrode can be dipped for soaking.

It is of advantage if several roller electrodes are provided for parallel treatment of several carriers. Alternatively or additionally, several roller electrodes can be provided for parallel treatment of the carrier. With that, the processing time can be shortened in case of large number of units and/or large areas.

Other advantages and details of the invention are explained further in the following with the help of a preferable exemplary embodiment described in the drawing, though not limited to the case of this exemplary embodiment. Shown are:

FIG. 1 Schematic view of a section of an electroluminescent light-emitting element;

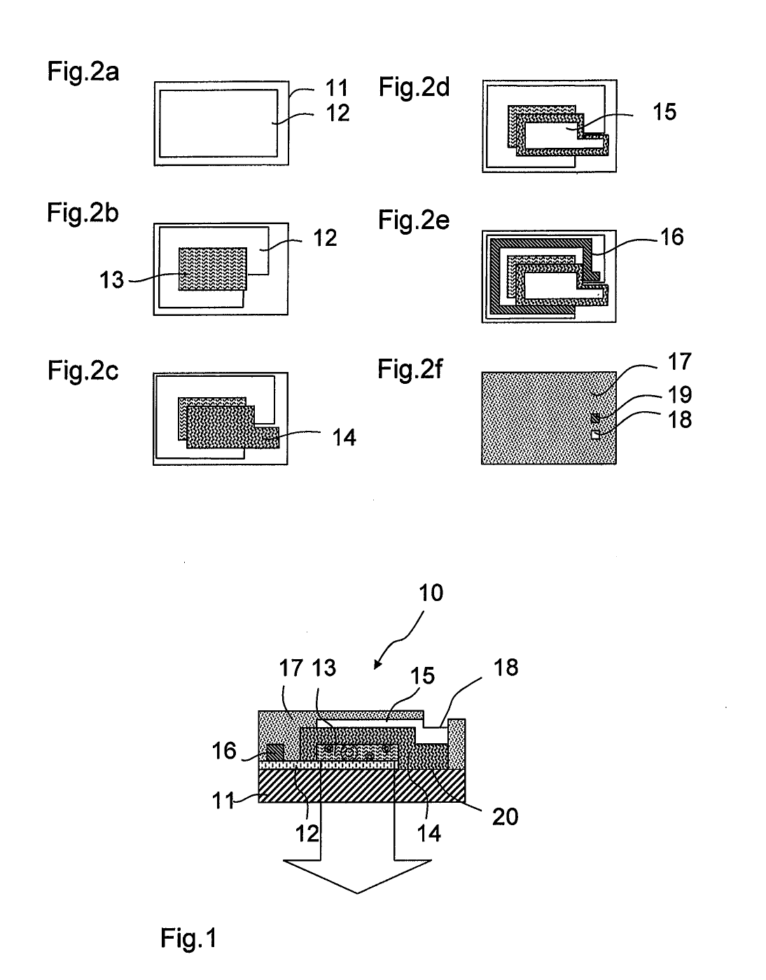

FIG. 2a-f Several processing steps in the production of a light-emitting element; and

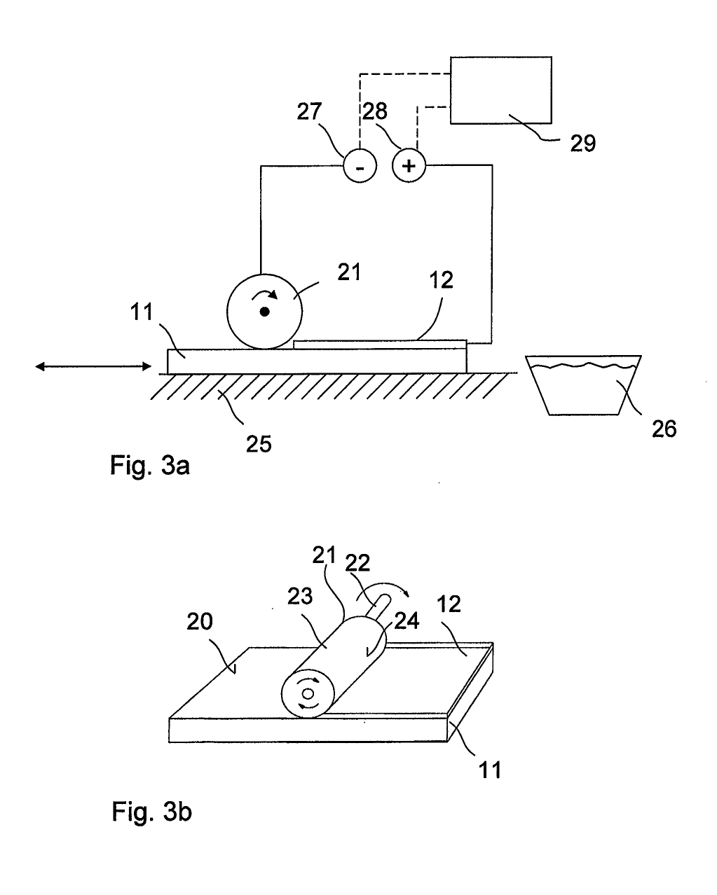

FIGS. 3a, b Schematic view of a device with a roller electrode (a) and a detail with the set-up roller electrode during the etching (b)

In the figures, same elements or elements with similar action are numbered with the same reference symbols.

As one can see in the sectional view in FIG. 1, an electroluminescent light-emitting element 10 comprises a transparent carrier 11 made of a PET film, on which a transparent electrode layer 12, in particular made of indium tin oxide, is deposited. On the transparent electrode layer 12, a luminous pigment layer 13 is arranged. The luminous pigment layer 13 preferably consists of the so-called microencapsulated luminous pigments of zinc sulfide, which are embedded in a binding agent, as indicated by the round symbols in the luminous pigment layer 13 (not true to scale) not further described here in detail. With it, the hygroscopic luminous pigments are protected against moisture. The commonly familiar colors, such as red, green, blue, etc. can be represented. Particularly advantageously, white color can also be represented, in which a blue-green electroluminescent microencapsulated luminous pigment is embedded in a red-colored binding agent. Alternatively, a mixture of red, blue and orange electroluminescent luminous pigments can be embedded in a transparent binding agent. Altogether, one obtains a white color, which is emitted through the transparent electrode layer 12 and the transparent carrier 11.

The luminous pigment layer 13 is embedded in an insulation layer 14, on which the metallic electrode layer 15, forming the rear electrode is deposited. In an area 20 in which the metallic electrode layer 15 is not covered, the transparent electrode layer 12 is removed, so that no capacitive interference due to an arrangement outside the electroluminescent area can arise.

Besides the insulation layer 14, a conductor structure 16 is provided, which is in electrical contact with the transparent electrode layer 12 and serves the purpose as a bus-bar structure.

The electrode layer 15 is covered with a protective layer 17 and is accessible from outside only at a contact area 18 in a recess of the protective layer 17. The conductor structure 16 exhibits just such a contact area 19 (FIG. 2f). If an electric voltage is applied between the conductor structure 16 and the rear electrode 15, a relatively sharp-band electroluminescence radiation is emitted from the front electrode due to the known electroluminesscence mechanisms, which is indicated by a thick arrow.

FIGS. 2a to 2f represent individual steps of coating in the production of such a light-emitting element 10. For the sake of better overview, only the new upcoming layers are indicated with the reference symbols. A transparent carrier 11, preferably made of PET film, is coated over its entire surface area with a transparent electrode layer 12 formed from indium zinc oxide (FIG. 2a). Preferably, this is done with cathode sputtering method. After that, the electrode layer 12 is etched electrochemically, in which process, an electrical voltage is applied between the electrode layer 12 and an acid-impregnated roller electrode 21 (FIG. 3) and the roller electrode 21 is guided over the electrode layer 12 or the carrier. On the structured electrode layer 12, a luminous pigment layer 13 is applied (FIG. 2b). Preferably, the luminous pigment layer 13 contains microencapsulated luminous pigments, which are embedded in a binding agent. On this luminous pigment layer 13, an insulation layer 14 is deposited (FIG. 2c). Preferably, the insulation layer 14 consists of barium titanate. Then, on the insulation layer 14, a metallic electrode layer 15 is deposited (FIG. 2d), and next to it, an electrically conducting, in particular metallic, conductor structure 16 is deposited (FIG. 2e). After that, the entire structure is covered with a protective layer 17, whereby only a contact area 18 for contact with the metallic electrode layer 15 and a contact area 19 for contact with the transparent electrode layer 12 (FIG. 2e) remain free. The protective layer 17 can be made of a suitable protective enamel and/or a protective film made of PP (polypropylene) or PET that is self-adhesive on one or both sides. The transparent electrode layer 12 together with its transparent carrier 11 forms a front electrode of the light-emitting element 10, while the metallic electrode layer 15 forms its rear electrode. The layers 12 to 17 are coated preferably with screen printing, while the transparent electrode layer 12 is preferably applied with cathode sputtering.

A device for electrochemical structuring of a transparent electrode layer 12 on a carrier 11 before the deposition of a luminous pigment layer 13 as done in a tampon method is shown in FIGS. 3a and 3b.

The carrier 11 is fixed on a depositing rack 25 and is brought in physical contact at its desired areas with a roller electrode 21 impregnated with an acid. A typical size of the carrier 11 is about 610 mm×1000 mm. Thinkable is, however, also a roller material. The roller electrode 21 is arranged in a displaceable manner relative to the transparent electrode layer 12, so that the roller electrode 21 preferably moves above the carrier 11. This is indicated by the double arrow.

A power supply unit 29 supplies the electric voltage, which is applied between the transparent electrode layer 12 and the roller electrode 21. The method can be employed both as a potentiostatic method with a constant voltage, or as a galvanostatic method with a constant current. Thereby the roller electrode 21 forms the cathode 27, while the transparent electrode layer 12 forms the anode. In the areas, in which the roller electrode 21 comes in contact with the transparent electrode layer 12, the latter is electrochemically cauterized. Thereby it is of advantage to roll the roller electrode 21 on the carrier 11 during the etching, as indicated in the front part of the roller electrode 21.

The roller electrode 21 can be impregnated with the acid between the etching steps by dipping it in an acid reservoir 26.

Preferably citric acid is used for impregnation of the roller electrode 21. The processing takes place preferably at room temperature. Citric acid with a concentration commercially available for domestic use has been found to be suitable. Voltage range found suitable for the etching is 10 to 50 volts with direct current, in particular 12 to 40 volts. The etching rate depends on different parameters, such as the contact pressure of the roller electrode 21, the conductivity of the transparent electrode layer 12, the concentration of the acid, the temperature and so on. The lower the resistance of the electrode layer 12, the higher is the observed etching rate. The roller electrode 21 can be moved above the carrier 11 with a velocity that is adjusted to the other processing parameters.

FIG. 3b illustrates the etching process in detail. The roller electrode 21 comprises an impregnable roller body 23 on a shaft 22. The roller body 23 consists for example of an acid-resistant textile or fleece, as known for instance in the conventional, so-called tampon coating method, in which the coats can be deposited on the substrates electrochemically.

If the roller electrode 21 is moved with the voltage applied and with its surface 24 in physical contact above the carrier 11, the acid in the roller body 23 cauterizes the transparent electrode layer 12 and leaves behind an exposed area 20 in the carrier 11.

### LIST OF REFERENCE SYMBOLS

10 Light-emitting element
11 Carrier
12 Transparent electrode layer
13 Luminous pigment layer
14 Insulation layer
15 Electrode layer
16 Electric conductor structure
17 Protective layer
18 Contact layer
19 Contact layer
20 Area
21 Roller electrode
22 Shaft
23 Roller body
24 Surface
25 Depositing rack
26 Reservoir
27 Cathode
28 Anode
29 Power supply unit

1. Method for production of an electroluminescent light-emitting element (10), in which a transparent electrode layer (12) is deposited on a carrier (11) and a transparent luminous pigment layer (13) and a counter-electrode layer (15) are deposited on the transparent electrode layer (12), characterized in that the transparent electrode layer (12) is structured electrochemically before the deposition of the luminous pigment layer (13).

2. Method according to claim 1, characterized in that a roller electrode (21) impregnated with an acid is brought in physical contact with the transparent electrode (12).

3. Method according to claim 2, characterized in that the roller electrode (21) is moved relative to the transparent electrode layer (12) while an electrical voltage is applied between the transparent electrode layer (12) and the roller electrode (21).

4. Method according to claim 3, characterized in that the roller electrode (21) is rolled on the carrier (11) during the etching.

5. Method according to claim 4, characterized in that an electric direct voltage in the range of 10 to 50 volts is applied between the roller electrode (21) and the transparent electrode layer (12).

6. Method according to claim 5, characterized in that the roller electrode (21) is impregnated with acid between the etching steps.

7. Method according to claim 6, characterized in that on contact with the roller electrode (21), the carrier (11) is exposed at areas, with specific recesses among them, of the electrode layer (12).

8. Method according to claim 7, characterized in that the roller electrode (21) is impregnated with citric acid.

9. Method according to claim 8, characterized in that the carrier (11), with the structured transparent electrode layer (12), is cleaned with water after the etching.

10. Device for using the method for production of an electroluminescent light-emitting element (10), in which a transparent electrode layer (12) is arranged on a carrier (11) and at least one luminous pigment layer (13) and one counter-electrode layer (15) are arranged on a the transparent electrode layer (12), characterized in that it is provided with a roller electrode (21) that can be impregnated with acid, with which roller electrode the transparent electrode layer (12) can be removed at least in some areas in course of its electrochemical path.

11. Device according to claim 10, characterized in that the roller electrode (21) is arranged rotatably.

12. Device according to claim 11, characterized in that it is provided with devices for actuating relative motion between the roller electrode (21) and the carrier (11).

13. Device according to claim 12, characterized in that the roller electrode (21) has a homogeneous surface (24).

14. Device according to claim 13, characterized in that the roller electrode (21) has a structured surface (24) with flat areas spaced with gaps.

15. Device according to claim 14, characterized in that an acid reservoir (26) is provided, in which the roller electrode (21) can be dipped for impregnation.

16. Device according to claim 15, characterized in that several roller electrodes (21) are provided for parallel treatment of several carriers (11).

17. Device according to claim 16, characterized in that several roller electrodes (21) are provided for parallel treatment of one carrier (11).
